(19) United States
(12) Patent Application Publication
(10) Pub. No.: US 2017/0178229 A1
(43) Pub. Date: Jun. 22, 2017

(54) SYSTEM AND METHOD FOR ADMINISTERING A FINANCIAL ACCOUNT

(71) Applicant: Richard Seoh Leng Koh, Singapore (SG)

(72) Inventor: Richard Seoh Leng Koh, Singapore (SG)

(21) Appl. No.: 15/381,838

(22) Filed: Dec. 16, 2016

Related U.S. Application Data
(60) Provisional application No. 62/269,147, filed on Dec. 18, 2015.

(51) Int. Cl. G06Q 40/02; G06Q 20/38

(52) U.S. Cl. CPC G06Q 40/02; G06Q 20/381

(57) ABSTRACT

System and method for administering a financial account. The system is a proactive pre-filling system comprising a pre-filling module that automatically pre-fills a financial account depending on a predetermined event, wherein the predetermined event is receiving, by the proactive pre-filling module, forecast electronic data representing a forecast volume for a current period.

### CROSS-REFERENCE TO RELATED APPLICATION

This application claims the benefit of priority of U.S. Provisional Patent Application No. 62/269,147 filed on Dec. 18, 2015, the content of which is incorporated herein by reference in its entirety for all purposes.

### FIELD OF INVENTION

The present invention relates broadly to a system and method for administering a financial account, in particular to a proactive pre-filling system and a method for proactively pre-filling a financial account.

### BACKGROUND

A sizable percentage of the transactions in the foreign exchange (FX) market comes from the financial activities of companies or individuals seeking to pay for/being paid for goods or services in another currency.

Many in this group prefer a fixed FX rate as they want the benefits of knowing upfront the FX rate that will be applied to their transactions, i.e. paying for the goods or services when they occur. With certainty in handling transactions involving a foreign currency, they can have a peace of mind of knowing the exact cost of the goods or services they are buying or selling.

In current systems and methods used by operators for buying or selling goods or services in a foreign currency, floating FX rates are typically utilized. Thus from the time a transaction takes place until the FX rate is applied onto the transaction by the respective banks of the parties to the transaction, the parties face FX risk, making such systems and methods less attractive.

On the other hand, in current systems and methods in which a fixed FX rate may be offered, the operator typically has to apply a sizeable mark-up compared to a current floating rate, such as an inter-financial institution FX rate, to hedge against unfavourable movements of the floating rate for the operator. Again, this makes such systems and methods less attractive.

Embodiments of the present invention provide a system and method for administering a financial account that seek to address at least one of the above problems.

### SUMMARY

In accordance with a first aspect of the present invention, there is provided a proactive pre-filling system comprising a pre-filling module that automatically pre-fills a financial account depending on a predetermined event, wherein the predetermined event is receiving, by the proactive pre-filling module, forecast electronic data representing a forecast volume for a current period.

In accordance with a second aspect of the present invention, there is provided a method for administering a financial account, wherein the financial account is automatically pre-filled depending on a predetermined event, wherein the predetermined event is receiving forecast electronic data representing a forecast volume for a current period.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram illustrating a proactive pre-filling system according to an example embodiment.

FIG. 2 shows a screenshot illustrating a Merchant FX Account View on the graphical user interface to the forecasting module in the system of FIG. 1, at the end of a first period.

FIG. 3 shows a screenshot illustrating a Merchant FX Account View on the graphical user interface to the forecasting module in the system of FIG. 1, at the start of a second period.

In FIGS. 4 (a) and (b) respective graphs are shown, illustrating that S&P 500 index data was non-stationary, but that the daily changes were stationary respectively.

FIG. 5 shows graphs illustrating values of time series A and time series B increasing together as the date increases.

FIG. 6 shows graphs illustrating the values of time series A and time series A lagged by one period increase together as the date increases.

FIG. 7 shows an autocorrelation function of time series A.

FIG. 8 shows a partial autocorrelation function of time series A.

### DETAILED DESCRIPTION

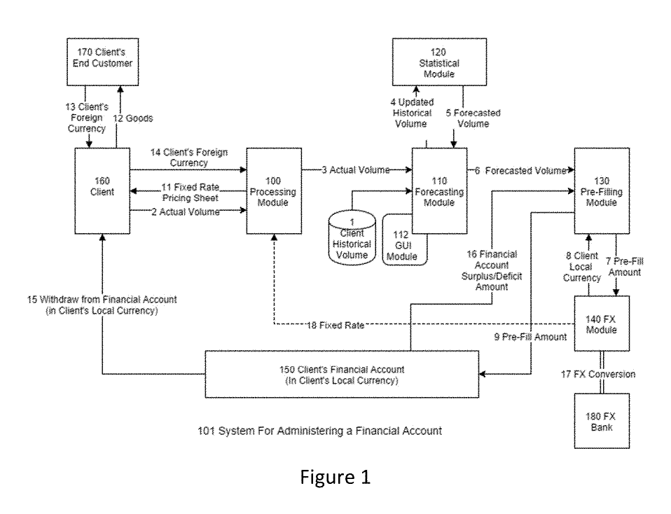

FIG. 1 shows a schematic diagram illustrating a proactive pre-filling system 101 according to an example embodiment. The system 101 comprises a pre-filling module 130 that automatically pre-fills a financial account 150, here shown as associated to a particular client 160.

The system 101 further comprises an electronic forecasting module 110, in this embodiment coupled to a statistical module 120 As will be appreciated by a person skilled in the art, forecasting on time series is typically done using automated statistical software packages and programming languages such as R, while other examples can be: S, SAS, SPSS, Minitab, Matlab, Pandas (Python).

At the end of each specified period, a processing module 100 retrieves an actual volume 2 transacted in relation to the financial account 150 in that period from the client(s) 160. The actual volume data 2 and client historical volume data 1 act as input into the forecasting module 110, i.e. for applying a time series analysis model for volume forecasting using the statistical module 120.

To perform the volume forecasting, the time series analysis model is scripted in R in the statistical module 120 in the example embodiment, but other software packages and programming languages can be used, as mentioned above. The statistical module 120 is preferably implemented in a programming language that offers an integrated suite of features for data manipulation and statistical calculation.

As will be appreciated by a person skilled in the art, R is a popular statistical programming language and software environment for statistical computing. It provides good graphic tools to visualize data. It is used among statisticians and data miners for analysing data and making any forecasting related to the data.

The volume forecasted by the statistical module 120 is passed back to the forecasting module 110.

A graphical user interface (GUI) module 112 is provided within, or coupled to, the forecasting module 110 to allow an operations team of the operating entity of the system 101 to view the actual volume and the volume forecast by the statistical module 120, as will be described in more detail below.

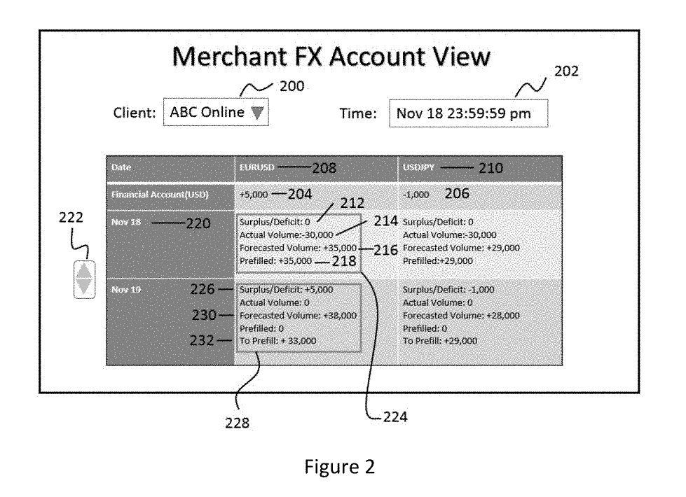

FIG. 2 shows a screenshot illustrating a Merchant FX Account View on the GUI 112 to the forecasting module 110. The view includes client name 200 (can be e.g. chosen in a dropdown list), current system time 202, the financial account amounts 204, 206 of e.g. EUR/USD and USD/JPY financial accounts 208, 210, and daily monitoring of surplus/deficit e.g. 212, actual volume e.g. 214, forecasted volume e.g. 216, prefilled e.g. 218, date e.g. 220 and a navigation button 222 to change dates.

The below description illustrates each amount when the first period (November 18 00:00:00-23:59:59) ends (i.e. current system time 202 is November 18 23:59:59, also referred to as cut-off time) and the second period (November 19 00:00:00-23:59:59) begins.

Box 224 is drawn for illustration purposes to emphasize the forecasted volume 216 as 35,000 and the system prefilled this 35,000 at 00:00:00 November 18. However, due to forecasting discrepancy, the actual volume 214 withdrawn at the cut-off time is only 30,000, resulting in 5000 left in the financial account 208. This 5,000 will be the November 19's (Next period) surplus/deficit 226. This 5,000 is also the amount for current financial account 204.

Box 228 is drawn for illustration purposes to emphasize the forecasted volume 230 as 38,000 for the next, i.e. the second period. This is computed by time series forecasting in the example embodiment, as will be described in more detail below. Due to the leftover or surplus amount 226 of 5,000, only 38,000−5,000=33,000 needs to be prefilled for the second period (as shown in to prefill 232) to achieve the forecasted amount of 38,000 for the second, i.e. November 19, period.

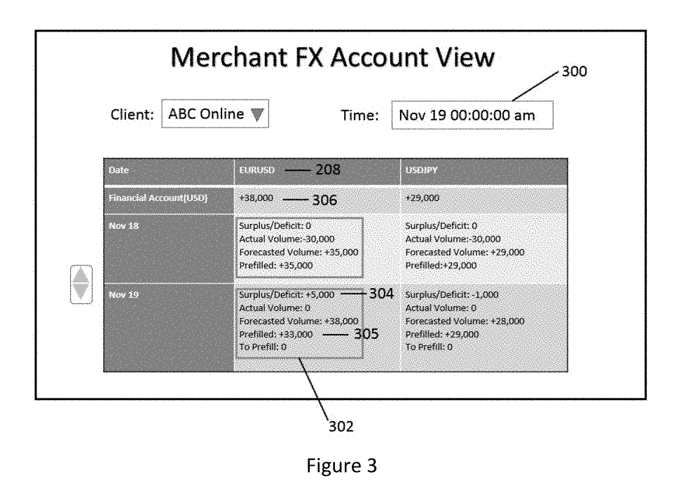

FIG. 3 shows the amount at the current system time 300 on 00:00:00 November 19 (start of the second, i.e. November 19, period). As emphasized in box 302, there is surplus/deficit 304 of 5,000, which is the amount left from the previous period November 18. The system has prefilled the account according to “to prefill” of November 19 (compare 232 in FIG. 2), and hence 33,000 was topped up (see numeral 305) into the financial account 208 and the current financial account amount 306 is 5,000+33,000=38,000.

Returning to FIG. 1, the forecasting module 110 is coupled to the pre-filling module 130. The pre-filling module 130 performs a pre-filling process for the financial account 150 automatically depending on electronic data representing the forecasted amount 6 received from the forecasting module 110. The pre-filling module 130 can be configured to prefill a certain percentage of the forecast volume based on certain rules and conditions.

The pre-filling module 130 is coupled to an FX module 140, for instructing FX orders to be sent to an FX bank 180 automatically for execution, indicated as FX conversion 17 in FIG. 1. The execution status can be feedback into the processing module 100 via the FX module 140, as well as a fixed rate 18, as will be described in more detail below.

The statistical module 120, in using time series analysis can preferably extract meaningful statistics and patterns from the historical FX transaction data which may otherwise appear as random. There are various modelling and forecasting techniques available in time series analysis. One model that has been found to work well to uncover hidden patterns in the data and generate forecasts is the ARIMA (Autoregressive Integrated Moving Average) methodology developed by Box and Jenkins [Box, George; Jenkins, Gwilym (1970). Time Series Analysis: Forecasting and Control. San Francisco: Holden-Day.] Model parameters are selected and tested by in house statisticians.

As the data to be forecast is seasonal, the model should preferably take that into account. For example, the transaction volume and frequency between weekdays, weekends and holidays may be different. To address this, a Seasonal ARIMA model is implemented in the R module 108 for forecasting in the example embodiment.

An explanation of ARIMA parameters and how to derive the parameters in an example embodiment is given below:

Stationarity of Time Series:

A stationary time series is one whose properties do not depend on the time at which the series is observed. So time series with trends, or with seasonality, are not stationary. The trend and seasonality will affect the value of the time series at different times. On the other hand, a white noise series is stationary. It does not matter when one observes it, it should look much the same at any period of time.

It has to be noted that a time series with cyclic behaviour (but not trend or seasonality) is stationary. In general, a stationary time series will have no predictable patterns in the long-term. Time plots will show the series to be roughly horizontal (although some cyclic behaviour is possible) with constant variance.

Differencing:

In FIG. 4(a), the S&P 500 index data 400 was non-stationary, but the daily changes 402 were stationary as illustrated in FIG. 4(b). This shows one way to make a time series stationary—compute the differences between consecutive observations. This is known as differencing. Differencing can help stabilize the mean of a time series by removing changes in the level of a time series, and so eliminating trend and seasonality. The differencing order is the number of times a time series is differenced.

Autoregression Model:

In an autoregression model, the variable of interest is forecasted using a linear combination of past values of the variable. The term autoregression indicates that it is a regression of the variable y against itself Thus an autoregressive model of order p can be written as

yₜ=c+φ₁y_{t 1}+φ₂y_{t 2}+ . . . , φₚy_{t p}+eₜ, (1)

where c is a constant and et is white noise, and the φₙ is the parameter for lagged n (n=1, 2, . . . p) value yₜ₋ₙ. In an example embodiment the value of φₙ is calculated by fitting Seasonal ARIMA in R using Maximum Likelihood method or Minimize Conditional Sum-of-Squares method. Both methods are estimation methods for estimating the parameters of a statistical model given data as understood by the person skilled in the art, and will not be described in more detail herein. Equation (1) is referred to herein as an AR (p) model.

Moving Average Model:

Rather than using past values of the forecast variable in a regression, a moving average model uses past forecast errors in a regression-like model and can be written (in order p) as:

yₜ=c+eₜ+θ₁eₜ₋₁+θ₂eₜ₋₂+ . . . +θ_{q}e_{t-q}, (2)

where eₜ is white noise and the θₙ is the parameter for forecast error n (n=1, 2, . . . q) value In an example embodiments, the value of θₙ is calculated by fitting Seasonal ARIMA in R using Maximum Likelihood method or Minimize Conditional Sum-of-Squares method. Both methods are estimation methods for estimating the parameters of a statistical model given data as understood by the person skilled in the art, and will not be described in more detail herein. Equation (2) is referred to herein as an MA(q) model.

Non-Seasonal ARIMA Model:

If one combines differencing with autoregression and a moving average model, one can obtain a non-seasonal ARIMA model. As mentioned above, the acronym ARIMA stands for Auto-Regressive Integrated Moving Average.

Seasonal ARIMA Model:

The seasonal ARIMA model incorporates both non-seasonal and seasonal factors in a multiplicative model. One shorthand notation for the model is

ARIMA(p, d, q)×(P, D, Q)S (3)

with p=non-seasonal AR order,
d=non-seasonal differencing order
q=non-seasonal MA order,
P=seasonal AR order,
D=seasonal differencing order,
Q=seasonal MA order, and
S=time span of repeating seasonal pattern.

For example, (1,1,0)(0,1,1)30 is short for p−1, d=1, q=0, P=0, D=1, Q=1 and S=30.

The technique of finding the best parameters for Seasonal ARIMA can be mastered with good theoretical understanding of relevant statistical concepts and practical experience in applying such concepts. Reference is made to http://people.duke.edu/˜mau/411home2.htm for a sophisticated way of finding the best parameters.

For general guidance, the process of deriving and finding the optimum parameters can be simplified to the below steps according to an example embodiment, without reducing model performance significantly from what can be achieved by the sophisticated method:

Step 1: Replace Outliers

Outliers are extreme values(ex: at least two standard deviation away from mean) to a time series(i). Identify such outliers and replace the outliers with appropriate data that conforms to the original pattern of the data using functions provided by statistical package (e.g. tsoutliers for R)

Step 2: Visualize Data to Check Seasonality

Visualize the data for first level checking of seasonality and stationality. The span of repeating pattern(S) can usually be determined using eyeballing method. Assume after observation one finds that the data has obvious weekly seasonality, namely S=7.

Step 3: Verify Seasonality

Verify the span of repeating seasonal pattern by differentiate the time series using S=7 hereafter referred to as time series (ii). If the seasonality goes away after applying the difference, one can continue the process with S=7. If not, one can try S=30, S=365 for monthly or annual seasonality or other span of repeating patterns that makes e.g. business sense to the data.

Step 4: Determine Differencing Order

This step is to determine the differencing order of time series (ii), namely order of Seasonal Arima D and Non-Seasonal Arima d. If the plot of (ii) from Step 3 does not look stationary, one can apply first difference to the time series to make it stationary.

After applying the first difference one will have a time series hereafter referred to as time series (iii). If applying e.g. Augmented Dickey-Fuller test (a test to determine stationarity of time series, as will be appreciated by a person skilled in the art) to time series (iii) and the test suggests the time series (iii) is stationary, one can say the time series (iii) has differencing order equal to 1, namely D=d=1.

If the time series (iii) is still not stationary, one can further difference the time series (iii) until it becomes stationary. Assume hereafter testing indicates D=d=1.

Step 5: Determine AR and MA Orders

Time Series Examples:

TABLE 1

| | | | Time Series A |
|---|---|---|---|
| Date | Time Series A | Time Series B | Lagged by 1 Period |
| 20151101 | 1.1 | 1.3 | 0.2 |
| 20151102 | 2.4 | 2.1 | 1.1 |
| 20151103 | 3.2 | 3.4 | 2.4 |
| 20151104 | 4.5 | 4.6 | 3.2 |
| 20151105 | 5.2 | 5.3 | 4.5 |
| 20151106 | 6.7 | 6.4 | 5.2 |
| 20151107 | 7.4 | 7.5 | 6.7 |
| 20151108 | 8.2 | 8.6 | 7.4 |
| 20151109 | 9.3 | 9.5 | 8.2 |
| 20151110 | 10.3 | 10.9 | 9.3 |
| 20151111 | 11.5 | 12.4 | 10.3 |
| 20151112 | 12.2 | 12.6 | 11.5 |
| 20151113 | 13.4 | 14.2 | 12.2 |
| 20151114 | 14.7 | 15.7 | 13.4 |
| 20151115 | 15.5 | 16.4 | 14.7 |
| 20151116 | 16.6 | 17.0 | 15.5 |
| 20151117 | 17.3 | 17.8 | 16.6 |
| 20151118 | 18.2 | 18.8 | 17.3 |
| 20151119 | 19.5 | 20.3 | 18.2 |
| 20151120 | 20.7 | 21.4 | 19.5 |

Table 1 contains three time series each with twenty data points, and they are time series A, time series B and time series A Lagged by one period (shifting Time Series A back one period)

Correlation: A correlation is a measure that shows the extent to which two time series fluctuate together.

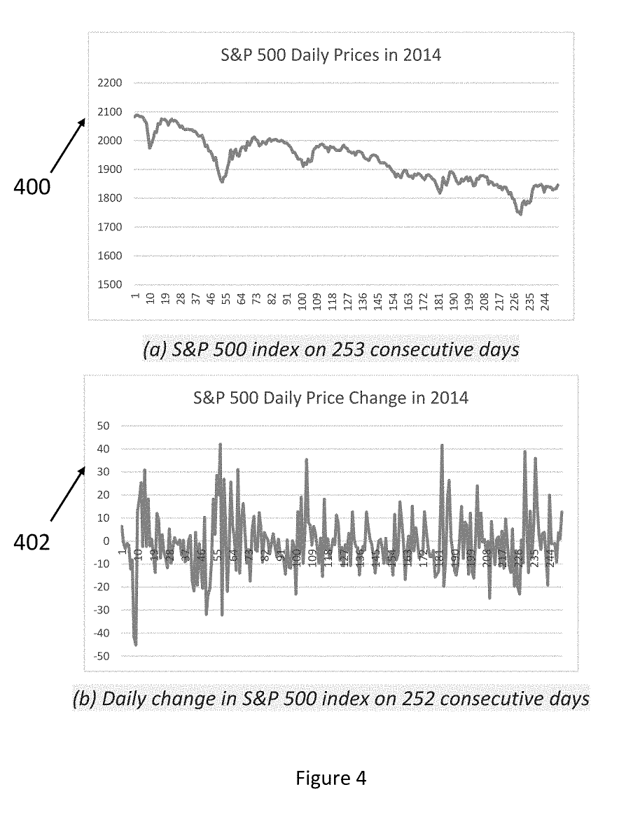

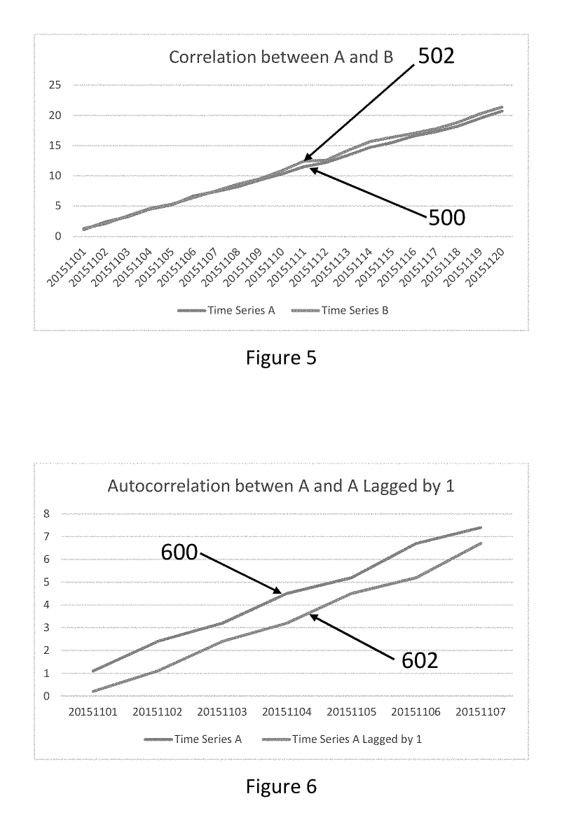

From Table 1 one can see that as the date increases, the values of A and B increase together, as illustrated in FIG. 5 (curve 500 for time series A, curve 502 for time series B).

Thus one can say there is positive correlation between Time Series A and Time Series B.

Autocorrelation: Autocorrelation refers to the correlation of a time series with its own past values.

From table 1 one can see that as the date increases, the values of A (Second Column in Table 1) and A lagged by one period (Fourth Column in Table 1) increase together, as illustrated in FIG. 6 (curve 600 for time series A, curve 602 for time series A lagged by one period).

Thus one can say there is positive correlation between Time Series A and Time Series A Lagged by 1 We can also say time Series A is at least autocorrelated with itself lagged by 1 period, and may be autocorelated with itself lagged by 2 period or more which can be examined by ACF and PACF introduced below.

Autocorrelation Function (ACF):

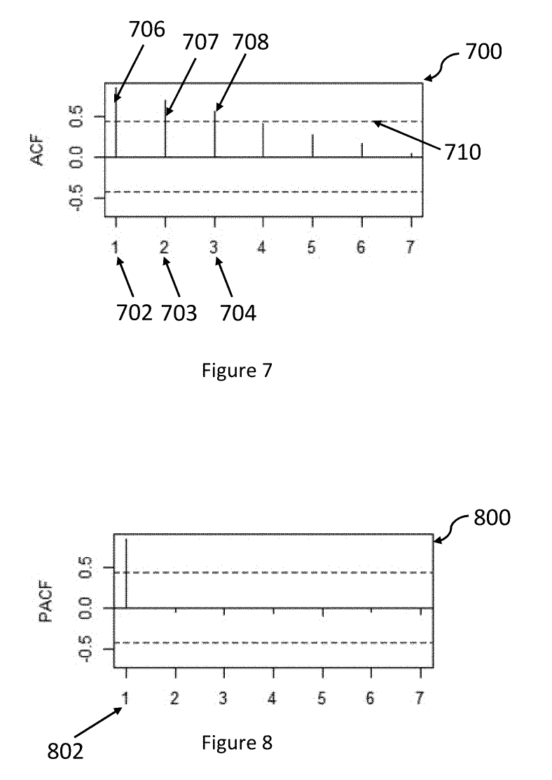

In time series analysis, Autocorrelation Function is the correlation of a time series with its own lagged values. An ACF diagram can be used to determine the autocorrelation order of a time series. For example, the above Time Series A has an autocorrelation function shown in FIG. 7.

The chart 700 shows that time series A is significantly autocorrelated with its own 1st lag 702, second lag 703 and third lag 704, as all the first three bars 706-708 are higher than the significance level indicated by the line 710, namely AR Order=3.

Partial Autocorrelation Function (PACF):

Partial autocorrelation function (PACF) gives the partial correlation of a time series with its own lagged values, excluding any correlation caused by shorter lags. For example, Time Series A has a partial autocorrelation function shown in FIG. 8.

The chart 800 shows that time series A is autocorrelated with only 1st lag 802, even though ACF indicates the first 3 lags are all significant (compare FIG. 7). This is because the autocorrelation is only caused by the first lag, namely any autocorrelation at other lags are all caused by the autocorrelation at first lag. Therefore AR order should be 1.

By observing ACF and PACF charts of the time series (iii) discussed above, one can determine AR and MA orders p, P, q and Q following similar logic as described above with reference to FIGS. 4 to 9. For a more sophisticated method reference is made to https://www.otexts.org/fpp/8/9 and http://people.duke.edu/˜mau/411arim3.htm. Assume by applying the proper statistical method on time series (iii) one finds that p=1, P=1 (AR Order=1) or q=1, Q=1 (MA Order=1). That is one can further fine tune the model using parameter set A: (1,1,0)(1,1,0)7 or set B: (0,1,1)(0,1,1)7.

Akaike information criterion (AIC) is a measure of the relative quality of statistical models for a given set of data. Given a collection of models for the data, AIC estimates the quality of each model relative to each of the other models. Hence, AIC provides a means for model selection.

One can now fit the model with given parameter set A and B. By comparing AIC of the two models, lower AIC will indicate a better model. Assume parameter set B gives a lower AIC, then one can proceed with parameter set B: (0,1,1)(0,1,1)7.

Step 6: Fine tune AR and MA Orders

Residuals are the difference between forecasted values and real values. Fitting the historical data with model (0,1,1)(0,1,1)7 will give a residual series. If the residual series reject Ljung Box test (a test to determine whether there is an autocorrelation), that is to say there is auto correlation of residual errors, one needs to further add AR order or MA order to the non-seasonal part of the model, namely increase p and q.

Each time one fine tunes the parameter set by increasing p or q, one can use AIC to determine how good the model is. The parameter set that yields lowest AIC is the best quality model. A sample AIC test table may look like shown in Table 2 below:

TABLE 2

| Parameter | Non-Seasonal | Seasonal | | |
|---|---|---|---|---|
| Set | Part | Part | Seasonality | AIC |
| 1 | (0, 1, 1) | (0, 1, 1) | 7 | −555 |
| 2 | (0, 1, 2) | (0, 1, 1) | 7 | −557 |
| 3 | (0, 1, 3) | (0, 1, 1) | 7 | −557 |
| 4 | (1, 1, 0) | (0, 1, 1) | 7 | −450 |
| 5 | (2, 1, 0) | (0, 1, 1) | 7 | −460 |
| 6 | (3, 1, 0) | (0, 1, 1) | 7 | −465 |
| 7 | (1, 1, 1) | (0, 1, 1) | 7 | −559 |
| 8 | (2, 1, 1) | (0, 1, 1) | 7 | −502 |
| 9 | (2, 1, 2) | (0, 1, 1) | 7 | −509 |

Step 7: Test Model Using Out of Sample Data

It is possible that multiple models give us similar AIC. As in the above table, parameter set 1, 2, 3 and 7 all give similar AIC. One can use out of sample testing (using additional data to test instead of original data which is used to train model) to further examine the forecasting power. One criterion for judging forecasting power is average absolute forecasting discrepancy, the average of the absolute difference between forecasted value and actual value.

The lowest average absolute forecasting discrepancy should give the model with most forecasting power for the current data set. This set of parameters will be used in forecasting in an application environment of an example embodiment.

In the following, the information flow in the example embodiment will be described. Before the start of each period, two tasks are performed.

Forecast the next period transaction volume using the Seasonal ARIMA model.

Generate the fixed FX rate based on a formula for the next period.

Returning to FIG. 1, using the forecast transaction volume 5 from the statistical module 120, the system 101 goes into the interbank FX market, here exemplified by the FX bank 180, via the FX module 140 to execute an FX order based on the forecast volume in anticipation of the actual transactions that will flow in during the next period.

The fixed FX rate 18 is preferably generated at approximately the same time as the FX order is executed, in one example embodiment immediately before the placing of the FX order for execution. This advantageously allows generating a fixed rate offered to the client(s) 160 that can be very close to the committed FX rate, i.e. the FX rate applied onto the FX order by the FX bank 180.

The fixed FX rate provided to the client(s) 160 may contain a markup. As long as the difference between the FX rates applied onto the FX order by the FX bank 180 during the prefilling and the fixed FX rate 18 provided to the client(s) 160 is less than the markup, FX risk for the operator of the system 101 is hedged (and minimized). The operator can therefore be relatively neutral to how the FX market will move during the (next) period.

At the end of each period, the actual volume 2 transacted in relation to the financial account 150 will act as input to the Seasonal ARMIA model implemented in the statistical module 120 for future forecasting, as described above.

The client 160 using the financial account 150 in this example embodiment can be e-commerce companies who are looking to convert revenue generated in foreign currency to the client's local currency. It is noted that the client is not only limited to e-commerce companies, and may additionally or alternatively be, by way of example, airline companies, hotel booking website or business entities with a need to convert floating FX rate to fixed FX rate. In the following, an example scenario and flow description is provided, by way of example and not limitation.

Scenario Description:

Assume a client 160 is a US e-commerce company mainly selling goods to Japan. The company needs a fixed USD/JPY rate so that its customers will be able to view the product catalogue in JPY instead of USD. Also, the company needs to make end of day conversion from the sales revenue in JPY (Foreign Currency) back to USD (Local Currency) to fund their business activities in the US.

The example embodiment is advantageously able to help the client 160 by maintaining a USD financial account 150 and guarantee a daily fixed rate 11 when the client 160 wants to do USD/JPY conversion.

Flow Description:

Forecasting:

At the start of the day, processing module 100 passes actual Volume 2 from client 160 to forecasting module 110. Forecasting module 110 will merge the actual volume 2 with client historical volume 1 and send updated historical volume 4 to the statistical module 120. Statistical module 120 will then build a model based on updated historical volume 4 and make a forecast for the next day's volume and output forecasted volume 5 back to forecasting module 110.

Pre-Filling:

Forecasting module 110 then sends forecasted volume 6 to pre-filling module 130. Pre-filling module computes the pre-fill amount 7 based on the two values—financial account surplus/deficit amount 16 and forecasted volume 6. It then sends the pre-fill amount to FX module 140. FX module 140 will do the FX conversion 17, namely sell JPY to buy pre-fill amount 7 of USD with FX bank 180 and send the USD amount (client local currency) 8 back to pre-filling module 130. Pre-filling module will then pre-fill client's financial account 150 with the pre-fill amount 9, which is typically equal to the received USD amount 8.

Sending Fixed Rate Pricing Sheet:

Upon the end of the/a first period, FX module 140 will use a proprietary algorithm to determine a, preferably fair, mid rate. Mid rate in one example is the mid price of best bid and best offer for a particular currency pair. It is used in an example as a benchmark price not favouring any party to an FX transaction. The FX module 140 then computes the fixed rate 18 by applying a markup to the mid rate and send this fixed rate 18 to the processing module 100. The processing module 100 will send a fixed rate pricing sheet 11 to the client 160 accordingly.

An example of a mid rate determination and how the mid rate and fixed rate are generated is given below:

(i) Mid Rate Illustration:

For example, FX banks will stream AUDUSD bid and offer prices to their clients in price ladder at a given point of time as shown in Table 3 below:

TABLE 3

| Bid Volume | USDAUD | Offer Volume |
|---|---|---|
| | 1.4169 | 2 Million |
| | 1.4168 | 1 Million |
| 1 Million | 1.4160 | |
| 2 Million | 1.4159 | |

The best Bid for USDAUD is 1.4160, which indicates for anyone to sell USD, the best price he can sell is 1.4160. The best Offer for USDAUD is 1.4168, which indicates for anyone to buy USD, the best price he can buy is at 1.4168.

Mid rate in one example is the average of best bid and best offer. In the above example, it is 1.4164=(1.4168+1.4160)/2.

(ii) Example Fixed Rate Generation Mechanism:

If a pricing sheet is to be sent out at 0:00:00, the mid rate can be determined as the average of all mid rates during a time interval close to 0:00:00. For example, one can compute mid rate every 30 seconds from 23:58:00 to 0:00:00. In the end there will be five mid rates and the average of these mid rates will serve as the mid rate used to determine the fixed rate in an example embodiment. An example calculation is given below:

TABLE 4

| Time | 23:58:00 | 23:58:30 | 23:59:00 | 23:59:30 | 00:00:00 |
|---|---|---|---|---|---|
| Mid Rate | 1.4163 | 1.4155 | 1.4158 | 1.4167 | 1.4162 |

Mid Rate=Sum of above Five mid rates/5=1.4161

Fixed Rate Calculation:

If the markup is 100 basis point (1%) in one example embodiment, then the fixed rate that will be sent to the client in the pricing sheet is calculated as Mid Rate*(1+markup)=1.4161*(1.01)=1.4303.

Client Carries Out Its Own Intraday Transactions:

Based on the fixed rate 11 given, the client 160 will quote the products on their website using customer's currency JPY. During the day, client's end customers 170 will purchase goods 12 from the client 160 and pay using JPY, namely client's foreign currency 13. Throughout the day, the client 160 accumulates payments from individual customers.

Client Withdraws Local Currency from Financial Account:

At the end of the day, actual volume 2 is calculated by the client 160 as the sum of the individual payments in JPY. The client 160 will then send the actual volume 2 and JPY, namely client's foreign currency 14 to the processing module 100. At the same time, the client will withdraw an USD amount that equals to the JPY amount exchanged at fixed rate 11, namely client's local currency 15, from financial account 150.

It is noted that despite preferably using the most accurate model to forecast the volume, the actual volume can be expected to inevitably differ from the forecast volume. The difference between the actual and forecast volume will advantageously be accounted for when the pre-filling is performed for the next period, as has already been described above with reference to FIGS. 2 and 3. In summary, if the financial account 150 was over pre-filled for the current period, there will be a leftover amount (Account Surplus). The pre-filling volume for the next period is adjusted to be decreased by the pre-filling module 130 so that at the start of the next period, the financial account 150 will be prefilled to the exact forecasted volume 6 (as forecast by the statistical module 120). Likewise, if the financial account 150 was under pre-filled, there will be a negative amount (Account Deficit). The pre-filling volume 7 for the next period is adjusted to be increased so that at the start of the next period, the financial account will be prefilled to the exact forecasted volume 6 (as forecast by the statistical module 120).

Embodiments of the present invention can provide a practical and automated method for pre-filling a financial account. In the context of the described example embodiment, by pre-filling the financial account for each (next) period, clients can be offered a fixed FX rate at the start of the period and can be guaranteed that they can use that rate to book an FX transaction anytime during that period. The described embodiments do not rely on the need to anticipate any FX movement direction in order to manage the FX risk. Instead, the example embodiments apply transaction volume forecasting using time series analysis to automatically pre-fill a financial account by executing FX order(s), effectively locking-in an obtained FX rate for the next period. The transaction volume forecasting is not only limited to time series analysis, other statistical modelling and forecasting method include regression, exponential smoothing, moving average or machine learning techniques including decision tree learning, artificial neural networks, genetic algorithms etc.

The present specification also discloses apparatus for implementing or performing the operations of the methods. Such apparatus may be specially constructed for the required purposes, or may comprise a device selectively activated or reconfigured by a computer program stored in the device. Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a device. The computer readable medium may also include a hard-wired medium such as exemplified in the Internet system, or wireless medium such as exemplified in the GSM mobile telephone system. The computer program when loaded and executed on the device effectively results in an apparatus that implements the steps of the method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

In one embodiment, a proactive pre-filling system comprises a pre-filling module that automatically pre-fills a financial account depending on a predetermined event, wherein the predetermined event is receiving, by the proactive pre-filling module, forecast electronic data representing a forecast volume for a current period.

At the start of the current period the pre-filling module may pre-fill the financial account with a first transaction volume determined based on the forecast electronic data representing the forecast volume for the period.

At the end of the current period, the pre-filling module may determine a second transaction volume based on further forecast electronic data representing the forecast volume for a next period and based on surplus/deficit electronic data representing a surplus/deficit of the financial account at the end of the current period. The second transaction volume may be reduced from the forecast volume for the next period if the surplus/deficit electronic data represents a surplus of the financial account at the end of the current period. The second transaction volume may be increased from the forecast volume for the next period if the surplus/deficit electronic data represents a deficit of the financial account at the end of the current period.

The pre-filling module may pre-fill the financial account by instructing an execution module to send a foreign exchange (FX) order to an FX bank for execution. The execution module may determine a fixed FX rate based on an average of one or more mid rates determined at approximately the same time as the FX order is sent to the FX bank for execution, each mid rate being determined based on one corresponding bid and offer price pair for a currency pair of the FX order. Each midrate may be determined as an average of the corresponding bid and offer price pair. The system may be configured to generate a fixed rate pricing sheet based on the fixed FX rate for offering to a client associated with the financial account. The system may be configured to receive a payment from the client in one currency of the currency pair of the FX order and to enable a withdrawal by the client from the financial account in the other currency of the currency pair. An amount of the payment may be based on the amount of the withdrawal multiplied according to the fixed rate pricing sheet.

The electronic forecasting module may determine the forecast volume based on historical data. The historical data may be updated at the end of the current period based on actual volume data for the current period. The electronic forecasting module may perform time series analysis based on the historical data. The time series analysis may comprise autoregressive integrated moving average (ARIMA) calculations. The time series analysis may take seasonal aspects into account. The seasonal aspects may comprise one or more of a group consisting of weekdays, weekends, and holidays.

In one embodiment, a method for administering a financial account is provided, wherein the financial account is automatically pre-filled depending on a predetermined event, wherein the predetermined event is receiving forecast electronic data representing a forecast volume for a current period.

At the start of the current period the financial account may be pre-filled with a first transaction volume determined based on the forecast electronic data representing the forecast volume for the period. At the end of the current period, a second transaction volume may be determined based on further forecast electronic data representing the forecast volume for a next period and based on surplus/deficit electronic data representing a surplus/deficit of the financial account at the end of the current period. The second transaction volume may be reduced from the forecast volume for the next period if the surplus/deficit electronic data represents a surplus of the financial account at the end of the current period. The second transaction volume may be increased from the forecast volume for the next period if the surplus/deficit electronic data represents a deficit of the financial account at the end of the current period.

The pre-filling of the financial account may be by instructing sending a foreign exchange (FX) order to an FX bank for execution. The method may comprise determining a fixed FX rate based on an average of one or more mid rates determined at approximately the same time as the FX order is sent to the FX bank for execution, each mid rate being determined based on one corresponding bid and offer price pair for a currency pair of the FX order. Each midrate may be determined as an average of the corresponding bid and offer price pair. The method may comprise generating a fixed rate pricing sheet based on the fixed FX rate for offering to a client associated with the financial account. The method may comprise receiving a payment from the client in one currency of the currency pair of the FX order and enabling a withdrawal by the client from the financial account in the other currency of the currency pair. An amount of the payment may be based on the amount of the withdrawal multiplied according to the fixed rate pricing sheet.

The forecast volume may be determined based on historical data. The historical data may be updated at the end of the current period based on actual volume data for the current period. The forecast volume may be determined by time series analysis based on the historical data. The time series analysis may comprise autoregressive integrated moving average (ARIMA) calculations. The time series analysis may take seasonal aspects into account. The seasonal aspects may comprise one or more of a group consisting of weekdays, weekends, and holidays.

Embodiments of the present invention differ from existing methods and systems at least in the technical implementation of the pre-filling of a financial account, wherein the electronic forecasting module is a technical means applied in the technical implementation of the pre-filling of the financial account.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the patent claims or the present embodiments.

1. A proactive pre-filling system comprising a pre-filling module that automatically pre-fills a financial account depending on a predetermined event, wherein the predetermined event is receiving, by the proactive pre-filling module, forecast electronic data representing a forecast volume for a current period.

2. The proactive pre-filling system of claim 1, wherein at the start of the current period the pre-filling module pre-fills the financial account with a first transaction volume determined based on the forecast electronic data representing the forecast volume for the period.

3. The proactive pre-filling system of claim 1, wherein at the end of the current period, the pre-filling module determines a second transaction volume based on further forecast electronic data representing the forecast volume for a next period and based on surplus/deficit electronic data representing a surplus/deficit of the financial account at the end of the current period.

4. The proactive pre-filling system of claim 3, wherein the second transaction volume is reduced from the forecast volume for the next period if the surplus/deficit electronic data represents a surplus of the financial account at the end of the current period, or wherein the second transaction volume is increased from the forecast volume for the next period if the surplus/deficit electronic data represents a deficit of the financial account at the end of the current period.

5. The proactive pre-filling system of claim 1, wherein the pre-filling module pre-fills the financial account by instructing an execution module to send a foreign exchange (FX) order to an FX bank for execution.

6. The proactive pre-filling system of claim 5, wherein the execution module determines a fixed FX rate based on an average of one or more mid rates determined at approximately the same time as the FX order is sent to the FX bank for execution, each mid rate being determined based on one corresponding bid and offer price pair for a currency pair of the FX order.

7. The proactive pre-filling system of claim 6, wherein the system is configured to generate a fixed rate pricing sheet based on the fixed FX rate for offering to a client associated with the financial account.

8. The proactive pre-filling system of claim 7, wherein the system is configured to receive a payment from the client in one currency of the currency pair of the FX order and to enable a withdrawal by the client from the financial account in the other currency of the currency pair.

9. The proactive pre-filling system of claim 1, wherein the electronic forecasting module determines the forecast volume based on historical data.

10. The proactive pre-filling system of claim 9, wherein the electronic forecasting module performs time series analysis based on the historical data.

11. A method for administering a financial account, wherein the financial account is automatically pre-filled depending on a predetermined event, wherein the predetermined event is receiving forecast electronic data representing a forecast volume for a current period.

12. The method of claim 11, wherein at the start of the current period the financial account is pre-filled with a first transaction volume determined based on the forecast electronic data representing the forecast volume for the period.

13. The method of claim 11, wherein at the end of the current period, a second transaction volume is determined based on further forecast electronic data representing the forecast volume for a next period and based on surplus/deficit electronic data representing a surplus/deficit of the financial account at the end of the current period.

14. The method of claim 13, wherein the second transaction volume is reduced from the forecast volume for the next period if the surplus/deficit electronic data represents a surplus of the financial account at the end of the current period, or wherein the second transaction volume is increased from the forecast volume for the next period if the surplus/deficit electronic data represents a deficit of the financial account at the end of the current period.

15. The method of claim 11, wherein the pre-filling of the financial account is by instructing sending a foreign exchange (FX) order to an FX bank for execution.

16. The method of claim 15, comprising determining a fixed FX rate based on an average of one or more mid rates determined at approximately the same time as the FX order is sent to the FX bank for execution, each mid rate being determined based on one corresponding bid and offer price pair for a currency pair of the FX order.

17. The method of claim 16, comprising generating a fixed rate pricing sheet based on the fixed FX rate for offering to a client associated with the financial account.

18. The method of claim 17, comprising receiving a payment from the client in one currency of the currency pair of the FX order and enabling a withdrawal by the client from the financial account in the other currency of the currency pair.

19. The method of claim 11, wherein the forecast volume is determined based on historical data.

20. The method of claim 19, wherein the forecast volume is determined by time series analysis based on the historical data.
